(19) United States
(12) Patent Application Publication
(10) Pub. No.: US 2026/0159052 A1
(43) Pub. Date: Jun. 11, 2026

(54) METHOD FOR DETERMINING A BRAKING VARIABLE FOR A VEHICLE

(71) Applicant: ZF CV Systems Global GmbH, Bern (CH)

(72) Inventors: Steffen Gerlach, Hannover (DE); Axel Stender, Hameln (DE); Alexander Rodenberg, Braunschweig (DE); Christoph Schowe, Gehrden (DE)

(21) Appl. No.: 19/358,179

(22) Filed: Oct. 14, 2025

Related U.S. Application Data
(63) Continuation of application No. PCT/EP2024/058446, filed on Mar. 28, 2024.

(30) Foreign Application Priority Data
Apr. 28, 2023 (DE) 10 2023 111 075.6

(51) Int. Cl. B60T 8/58; B60G 11/27; B60T 8/17; B60T 8/171; B60T 8/172; B60T 8/18; G01L 9/00

(52) U.S. Cl. CPC B60T 8/58; B60T 8/1708; B60T 8/171; B60T 8/172; B60T 8/1837; B60T 8/1887; G01L 9/0033; B60G 11/27; B60G 2202/152; B60G 2400/51222; B60T 2250/00

(57) ABSTRACT

A method for determining a braking variable for a vehicle, in particular a utility vehicle, wherein the vehicle includes a pneumatic suspension system having a bellows and the vehicle includes a pressure sensor for sensing a bellows pressure of the bellows. The method includes: sensing the bellows pressure; ascertaining a bellows pressure change on the basis of the bellows pressure; and determining the braking variable on the basis of the bellows pressure change.

### CROSS-REFERENCE TO RELATED APPLICATIONS

This application is a continuation application of international patent application PCT/EP2024/058446, filed Mar. 28, 2024, designating the United States and claiming priority from German application 10 2023 111 075.6, filed Apr. 28, 2023, and the entire content of both applications is incorporated herein by reference.

### TECHNICAL FIELD

The disclosure relates to a method for determining a braking variable for a vehicle, in particular a commercial vehicle, wherein the vehicle, in particular the commercial vehicle, has a pneumatic suspension system having a bellows and has a pressure sensor for capturing a bellows pressure of the bellows. The disclosure also relates to a computer program and/or computer-readable medium, a control device for a vehicle, in particular a commercial vehicle, and a vehicle, in particular a commercial vehicle, having a pneumatic suspension system including a bellows and a pressure sensor for capturing a bellows pressure of the bellows.

### BACKGROUND

The vehicle, in particular the commercial vehicle, is referred to below as vehicle. A vehicle of this kind has a plurality of wheels. One or more of the wheels makes contact with an underlying surface via a respective wheel contact area. In this case, a braking force can denote the force acting counter to the speed of travel in the vehicle longitudinal direction in each wheel contact area during braking or deceleration of the vehicle. It is not possible to ascertain exactly the braking force while operation is in progress, that is, during driving or during braking, since it is not possible to arrange sensors for measuring the braking force in the wheel contact areas.

Monitoring the braking force and/or a braking variable correlated with the braking force may be desirable in order to obtain information on a state or possible defects of a brake producing the braking force, of a braked wheel and/or of a component of the braked wheel or of the brake. In other words, such on-board measurement may be of interest for monitoring the current braking power of a vehicle, for example, for carrying out an automated driving function, for taking account of prescribed servicing intervals, and/or for planning servicing and/or inspections.

The state may be ascertained as part of legally and/or operationally defined checks, for example. However, it is possible to ascertain the state and possible defects only with difficulty during operation. Some processes, for example, a change in the brake pad, can take place gradually, which may lead to greater difficulty in perception by a driver of the vehicle. Moreover, a decline in a braking effect of one brake can be compensated for by another brake, particularly in the case of a multi-unit vehicle.

There is a known practice from the prior art of measuring the braking force via strain gages or force sensors, or directly via height sensors.

EP 3 753 794 A1 discloses a method for monitoring a braking power of a vehicle, in particular of a trailer of a commercial vehicle. The method includes: collecting sensor data from various sensors, wherein the sensor data are assigned to braking events; determining at least one braking power value using the sensor data on the basis of at least one of the following analyses: (i) statistical analysis on the basis of multiple regression; (ii) braking force loss analysis on the basis of a comparison of wheel speed values of various wheels; (iii) air suspension pressure analysis on the basis of a comparison of a change in an air suspension pressure during braking. The method further includes detecting a malfunction of at least one brake of at least one wheel on the basis of the at least one braking power value determined. In this case, the suspension pressure analysis can include: determining the air suspension pressure at one or more wheels, on the basis of sensor signals from one or more height sensors for controlling or measuring one or more bellows.

WO 2016/030699 A1 discloses a method for monitoring the braking power of a vehicle. For at least some of the braking events, the method includes: determining a braking request; determining a vehicle deceleration; defining a first dataset of braking events, wherein each braking event in the dataset includes a particular braking request and a particular vehicle deceleration; applying a statistical trend analysis method to the dataset in order to generate a vehicle-deceleration and braking-request trend; providing a vehicle-deceleration and braking-request reference; and comparing at least one trend value with at least one reference value. From this comparison, it is possible to determine whether the braking system is operating within an acceptable limit. A device for implementing the method is likewise disclosed. Here, the braking events can be categorized into a plurality of categories on the basis of a vehicle payload.

However, additional sensors lead to increased effort, to an increased weight and to increased costs.

It is furthermore possible to ascertain the braking force by evaluating the deceleration of a multi-unit vehicle. However, such evaluation can be subject to errors. Moreover, such evaluation cannot differentiate which vehicle of a multi-unit vehicle or combination of vehicles is responsible for a deceleration which is too high or too low in relation to a braking request. Sustained-action brakes, for example, retarders, engine brakes or, alternatively, electric drive axles, which are used to recover the braking energy, can lead to a significant deceleration and thus affect the result.

Direct braking force measurement is also known from the prior art.

German Patent Application DE 10 2022 127 155.2, which was not published on the filing date of the disclosure, describes a method for monitoring the braking effect of a vehicle having a running gear, wheels, brakes and an electronic braking system. In this case, a trailer vehicle having supporting bellows is disclosed, wherein a pressure sensor, the data from which represent an axle load and are transmitted to the brake control device, is arranged on a supporting bellows. The axle load can be detected for the purpose of calculating a setpoint braking force.

### SUMMARY

It is an object of the disclosure to enable improved determination of a braking variable. The disclosure achieves the object of effectively and reliably determining the braking variable, even independently of the effects of different vehicle units in the case of a multi-unit vehicle.

According to an aspect of the disclosure, a method for determining a braking variable for a vehicle, in particular a commercial vehicle, is provided. In this case, the vehicle, in particular the commercial vehicle, has a pneumatic suspension system having a bellows and has a pressure sensor for capturing a bellows pressure of the bellows, and the method includes: capturing the bellows pressure; ascertaining a bellows pressure change on the basis of the bellows pressure; and determining the braking variable on the basis of the bellows pressure change.

In this case, it has been recognized that the braking variable, which can act on one of the wheels, may have an effect on the pressure within the bellows. Braking a wheel leads to a braking torque acting on the wheel, and the braking torque leads to a force on the bellows. Here, the bellows is configured to control an arrangement of the wheel relative to, for example, a vehicle frame of the vehicle. In this case, the pressure within the bellows may change, for example, on account of pressure control that counteracts the force, compression of the bellows or expansion of the bellows. Thus, braking the vehicle may lead to a change in the bellows pressure. The bellows pressure can be captured by sensors in order to ascertain the bellows pressure change.

It has been recognized that there is a relationship between the bellows pressure change and the force acting on the bellows, and that the force acting on the bellows depends on the braking variable. Therefore, the bellows pressure change may be used to determine the braking variable. In order to determine the braking variable, the bellows pressure change can be multiplied by a constant, in particular a vehicle-specific or vehicle-type-specific constant, and/or additional contributions can be taken into account to increase accuracy.

On-board measurement of the braking variable of a vehicle and, in particular, of a trailer vehicle is thereby possible. Particularly in the case of a trailer vehicle, determining the braking variable is possible in a manner very largely independent of effects due to the tractor. Determining the braking variable avoids the need for additional sensors, such as height sensors, force sensors or strain gages, and it enables reliable and effective determination of the braking variable. It is possible to avoid the need, for example, to perform height measurement and the need to convert a change in height into a change in volume of the bellows via a complicated relationship in order to infer the braking force.

As an option, the bellows pressure change corresponds to a difference between the bellows pressure and a reference bellows pressure at and/or before an effect of the braking variable. In this case, it has been recognized that, without an effect of the braking variable, that is, before a braking operation or braking, the bellows has a bellows pressure which is set for the operation of the air spring system. The pressure changes on account of the braking operation and the action of the braking variable. As a result, the bellows pressure at and/or before the effect of the braking variable can be a suitable reference bellows pressure for ascertaining the bellows pressure change. The bellows pressure change can then be the difference between the detected bellows pressure during the braking operation and the reference bellows pressure.

As an option, the determination of the braking variable is performed while taking account of a length of a suspension link mounted rotatably on a vehicle frame and of a height of a mounting of the suspension link. Here, it has been recognized that the suspension link forms a lever which can transmit the braking variable from the wheel to the bellows. In this case, the vehicle has the mounting for the rotatable or pivotable mounting of the suspension link. In this case, the mounting is arranged at a height above an underlying surface or relative to a wheel contact area. On the basis of the length of the suspension link and the height of the mount, the braking variable can be determined as a function of the force acting on the bellows and thus of the pressure change. Alternatively or in addition, this purpose is served by determining the braking variable while taking account of the ratio of the length to the height. The height, the length and the ratio or quotient thereof are vehicle-specific or vehicle-type-specific constants.

As an option, the determination of the braking variable is performed while taking account of an area of action of the bellows. Here, it was recognized that a relationship between the bellows pressure and thus the bellows pressure change and the force acting on the bellows depends on the effective area of action of the bellows. The effective area of action of the air spring bellows can be measured, input and/or ascertained from data from a load-dependent braking force calculation. The corresponding data are typically stored as a relationship between the bellows pressure and the braking force in a control device on the vehicle, for example, a brake control device on a trailer vehicle.

As an option, the determination of the braking variable is performed while taking account of an axle load transfer. Here, it was recognized that an axle load transfer may lead to a bellows pressure change. By taking account of the axle load transfer, it is possible to take account of an additional contribution to the determination of the braking variable in order to increase the accuracy of the braking variable.

As an option, the axle load transfer is ascertained while taking account of a vehicle deceleration, a center of gravity height, a pin braking force acting on a kingpin, a pin height of the kingpin, a number of axles and/or an effective wheelbase. It is thereby possible to take account of variables that are relevant to the driving dynamics and axle load transfer in order to effectively increase the accuracy of the braking variable. By taking account of the pin braking force and of the pin height, it is possible to take account of an effect of braking of a tractor on the axle load transfer of a trailer vehicle. The number of axles and the effective wheelbase resulting from the wheelbases of, potentially, a plurality of axles can simplify the process of taking the axle load transfer into account.

As an option, the determination of the braking variable is performed when a braking operation exceeds a minimum braking duration. This makes it possible for the braking variable to be determined only when the forces acting on the bellows have assumed a largely steady state. Here, it was recognized that, even at a constant brake pressure, the vehicle exhibits a transient response during a braking operation on account of its mass, and this affects the bellows pressure resulting from the driving dynamics and the braking, whereas, after the transient response, the bellows pressure is decisively determined by the braking. The minimum braking duration can be, for example, 1 seconds to 3 seconds, for example, 2 seconds, in order to enable improved determination of the braking variable. Alternatively or in addition, shorter braking operations can be considered, in particular while taking account of the dynamics of the forces and/or torques. For example, brake-pressure and bellows-pressure gradients and/or higher time derivatives can be evaluated for this purpose.

As an option, the determination of the braking variable is performed in a plurality of braking operations, and the braking variables assigned to the braking operations are statistically evaluated. For example, the braking variables of the plurality of braking operations can be averaged in order to enable more accurate determination of the braking variable.

As an option, the braking variable includes a braking force and/or braking ratio. In this case, the braking force can denote the force acting counter to the speed of travel in the vehicle longitudinal direction in a wheel contact area during braking or deceleration of the vehicle. The braking ratio can be the ratio or quotient of the braking force and a load, in particular an axle load. The braking variable can therefore be determined according to the application.

As an option, the vehicle, in particular the commercial vehicle, has a braking system, a control device for controlling the braking system and a data processing device, wherein the method for determining the braking variable includes: transmitting the bellows pressure change and/or the bellows pressure from the control device to the data processing device. In this case, a vehicle-specific and/or vehicle-type-specific constant can be stored in the data processing device, and/or the data processing device can be configured for wireless communication and can call a vehicle-specific and/or vehicle-type-specific constant from a server external to the vehicle. The determination of the braking variable can therefore be performed by the data processing device. Alternatively, it is possible for the data processing device to transmit the bellows pressure change and/or the bellows pressure and optionally vehicle-specific parameters, for example, the length of the longitudinal links and reference forces, to the server external to the vehicle in order to determine the braking variable. In any event, the control device can be a brake control device or central control device. It is thus possible to enable determination of the braking variable even for existing vehicles without major effort, that is, to provide a possibility of retrofitting. In the simplest case, such retrofitting can be an update of the data processing device. The data processing device can be a telematics device.

According to an aspect of the disclosure, a computer program and/or computer-readable medium are/is provided, including commands which, when the program or the commands is or are executed by a computer, cause the latter to carry out the method described above and/or the steps of the method described above. As an option, the computer program and/or the computer-readable medium include(s) commands which, when the program or the commands is or are executed by a computer, cause the latter to implement a feature, described as optional or advantageous, of the method described above in order to achieve a technical effect associated therewith.

According to an aspect of the disclosure, a control device for a vehicle, in particular a commercial vehicle, is provided. The control device here is configured to carry out the method described above. As an option, the control device is configured to implement a feature, described as optional or advantageous, of the method described above in order to achieve a technical effect associated therewith.

For determination of the braking variable, the control device is optionally configured for transmitting the bellows pressure change and/or the bellows pressure to a data processing device, different from the control device, on the vehicle, in particular the commercial vehicle. Here, the data processing device can effect determination of the braking variable. This ensures that only data relating to the bellows pressure or the bellows pressure change have to be processed, in particular captured and transmitted, by the control device, for example, a brake control device or a central control device on a trailer.

As an option, the data processing device is configured for wireless communication. This makes it possible for the bellows pressure change and/or the bellows pressure to be transmitted by the data processing device to a server external to the vehicle, wherein the braking variable can be determined by the server external to the vehicle. This ensures that the control device and the data processing device can be configured in a manner that is economical in terms of resources. Moreover, this enables the possibility for retrofitting an existing vehicle, in particular commercial vehicle, since only the bellows pressure change and/or the bellows pressure have to be captured and transmitted in order to determine the braking variable.

According to an aspect of the disclosure, a vehicle, in particular a commercial vehicle is provided, having a pneumatic suspension system including a bellows and having a pressure sensor for capturing a bellows pressure of the bellows and having an above-described control device connected to the pressure sensor.

As an option, the vehicle, in particular the commercial vehicle, is a trailer of a multi-unit vehicle. Thus, determination of the braking variable is performed in the trailer vehicle, in particular a semitrailer. In principle however, the method described above can also be applied to tractors or vehicles of which the axles have running gear configurations comparable to trailer vehicles and on which the braking torque is supported via the air spring bellows.

### BRIEF DESCRIPTION OF DRAWINGS

The invention will now be described with reference to the drawings wherein:

FIG. 1 shows a schematic illustration of a vehicle, in particular a commercial vehicle, according to an aspect of the disclosure;

FIG. 2 shows a schematic illustration of a detail of a vehicle, in particular a commercial vehicle, according to an aspect of the disclosure;

FIG. 3 shows a schematic illustration of a trailer as a vehicle, in particular a commercial vehicle, according to an aspect of the disclosure;

FIG. 4 shows a schematic illustration of a trailer as a vehicle, in particular a commercial vehicle, according to an aspect of the disclosure;

FIG. 5 shows a schematic illustration of a flow chart of a method according to an aspect of the disclosure;

FIG. 6 shows braking forces obtained via a method according to an aspect of the disclosure as a function of the brake pressure; and,

FIG. 7 shows braking forces obtained via a method according to an aspect of the disclosure as a function of the brake pressure.

### DETAILED DESCRIPTION

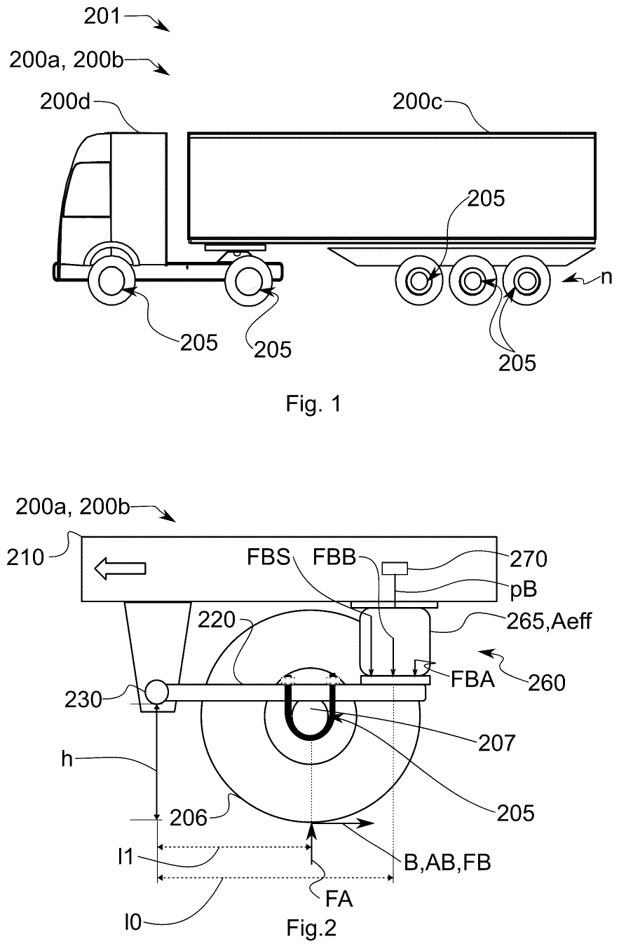

FIG. 1 shows a schematic illustration of a vehicle 200a, in particular a commercial vehicle 200b, according to an aspect of the disclosure.

The vehicle 200a, in particular the commercial vehicle 200b, is referred to below as vehicle 200a, 200b. The vehicle 200a, 200b is a land vehicle. The vehicle 200a, 200b is a multi-unit vehicle 201, also referred to as a vehicle combination, and, in the example shown, has a tractor 200d and a trailer 200c, also referred to as a trailer vehicle, coupled to the tractor 200b. In another embodiment, the vehicle 200a, 200b may also have a plurality of trailers 200c (not shown).

A vehicle 200a, 200b of this kind has a plurality of n axles 205 indicated schematically. On each of the axles 205, the vehicle 200a, 200b has wheels 206 assigned to the respective axle 205 (see FIG. 2). One or more of the wheels 206 makes contact with an underlying surface (not shown) via a respective wheel contact area. In this case, a braking force FB (see FIGS. 2 to 4) can act as a force acting counter to the speed of travel in the vehicle longitudinal direction in each wheel contact area during braking or deceleration of the vehicle 200a, 200b. The braking force FB is a braking variable B. A braking ratio AB is likewise a braking variable B, which characterizes the deceleration of the vehicle 200a, 200b. Here, the braking ratio AB is defined, for example, as the ratio of the braking force FB to an axle load FA.

Details of the vehicle 200a, 200b are described with reference to FIGS. 2 to 4.

FIG. 2 shows a schematic illustration of a detail of a vehicle 200a, in particular a commercial vehicle 200b, according to an aspect of the disclosure. In this case, FIG. 2 shows an axle configuration. An axle configuration of this kind or an axle configuration that acts in a similar way in principle is typical of trailer vehicles.

Accordingly, the vehicle 200a, 200b has a vehicle frame 210. The vehicle frame 210 is a sheet-metal and/or tubular structure and has a load bearing function, and running gear components are connected to the vehicle frame 210. In particular, the vehicle 200a, 200b has a pneumatic suspension system 260, which has components connected to the frame.

In particular, the pneumatic suspension system 260 includes a bellows 265 or air spring bellows assigned to a wheel 206 and/or an axle 205. The vehicle 200a, 200b includes a device for supplying compressed air to fill the bellows 265 (see FIG. 4). It is possible to fill the bellows 265 and/or to vent the bellows 265 via valves 297 (see FIG. 4) on the vehicle 200a, 200b.

The vehicle 200a, 200b includes an axle tube 207 forming the axle 205. On each side, the axle tube 207 is firmly connected to a suspension link 220 of the vehicle 200a, 200b. At one end of the suspension link 220, the suspension link 220 is connected rotatably to the vehicle frame 210 by a mounting 230 including a bolt. The bellows 265, with the aid of which the vehicle 200a, 200b can be sprung and damped and the axle 205 can optionally be adjusted in height, is arranged at the other end of the suspension link 220, that remote from the mounting 230. For this purpose, the suspension link 220 is connected to the axle tube 207. A distance l1 between the mounting 230 and the axle 205 or the axle tube 207 defines a length of a lever supported on the mounting 230 and engaging on the axle 205. The distance l1 between the mounting 230 and the axle 205 can be measured and is a vehicle-specific or vehicle-type-specific constant.

The vehicle 200a, 200b includes a pressure sensor 270. The pressure sensor 270 is configured to measure a bellows pressure pB. The pressure sensor 270 can be configured to measure bellows pressures pB of a plurality of bellows 265 (see FIG. 4). Here, the bellows pressure pB is the pressure which prevails in the interior of the bellows 265. The bellows 265 has an area of action Aeff which, together with the bellows pressure pB, defines a force imparted by the bellows 265.

The mounting 230 is arranged at a height h. The height h is defined as the vertical distance between the mounting 230 and the underlying surface and/or the wheel contact area. The height h can be measured and/or can be estimated from a radius of the wheel 206. The height h is essentially a vehicle-specific or vehicle-type-specific constant.

The suspension link 220 has a length l0 of the suspension link 220. The length l0 of the suspension link 220 is defined as the distance between the mounting 230 and the bellows 265 along the suspension link 220. The length l0 of the suspension link 220 thus defines a length of a lever arm supported on the mounting 230 and engaging on the bellows 265. The length l0 of the suspension length 220 can be measured and is a vehicle-specific or vehicle-type-specific constant.

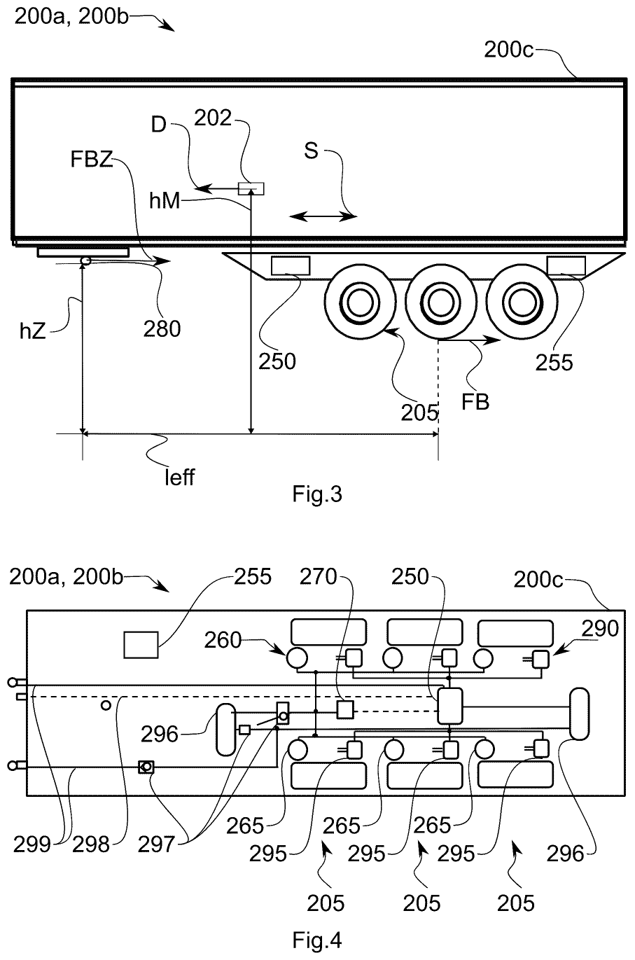

The vehicle 200a, 200b has a brake system 290 (not shown in FIG. 2; see FIG. 4) for braking the wheel 206. The braking system 290 is configured to exert a braking torque on the wheel 206 in order to decelerate the rotary motion of the wheel 206 via a braking force FB acting in the wheel contact area. By virtue of the configuration shown in FIG. 2, a braking torque acting on the wheel 206, and thus the braking force FB, leads to a counterforce on the bellows 265 or a braking force FBB on the bellows 265. The braking force FB thus leads to a bellows pressure change pD in the bellows 265. The bellows pressure pB and thus the bellows pressure change pD as well as a brake pressure BP with which the braking system 290 is supplied can be measured via the pressure sensor 270 and can be transmitted to a control device 250 of the vehicle 200a, 200b (see FIGS. 3 and 4).

The forces FBA, FBS, FBB acting on the bellows 265 include the following components: a static force FBS on the bellows 265, that is, a force resulting from a static contribution of the axle load FA; a braking force FBB resulting from support for the braking torque, and a force FBA due to an axle load transfer S, that is, a dynamic axle load transfer during deceleration or a dynamic contribution of the axle load FA.

The forces FBA, FBS, FBB and the bellows pressure pB are in the following relationship: FBA+FBS+FBB=pB×2×Aeff. In other words, the sum of the force FBA on the bellows 265 due to the axle load transfer S plus the static force FBS on the bellows 265 plus the braking force FBB on the bellows 265 is equal to twice the product of the bellows pressure pB and the area of action Aeff. Here, the number two results from the number of bellows 265 per axle 205, is a vehicle-specific or vehicle-type-specific constant and, in other embodiments, may be an entirely different number.

One way in which the individual components of the forces FBA, FBS, FBB acting on the bellows 265 can be calculated is explained below.

The effective area of action Aeff of the bellows 265 can be measured or ascertained from data from a load-dependent braking force calculation or can be taken from the datasheets provided by the bellows or axle manufacturer and is a vehicle-specific or vehicle-type-specific constant. The corresponding data from the load-dependent braking force calculation are typically stored in a control device 250, in particular a brake control device of a trailer vehicle. In this case, a relationship between a mass of the vehicle 200a, 200b and the bellows pressure pB is typically stored in the control device 250. The area of action Aeff is then obtained as (mb−mu)×g×l1/(2×(pb−pu)×l0), where mb is the mass of the laden vehicle 200a, 200b, mu is the mass of the unladen vehicle 200a, 200b, pb is the bellows pressure pB of the laden vehicle 200a, 200b, pu is the bellows pressure pB of the unladen vehicle 200a, 200b, l0 is the length of the suspension link 220, l1 is the distance between the mounting 230 and the axle 205, and g is the location factor.

The force FBS resulting from the static axle load on the bellows 265 is equal to the product of the static component of the axle load FA, statisch and the distance l1 between the mounting 230 and the axle 205 divided by the length l0 of the suspension link 220: FBS=FA,statisch×l1/l0.

By observing and storing the bellows pressure pB at the start of braking, a suitable reference pressure pRef for the bellows pressure change pD can be formed, and therefore only one evaluation of the bellows pressure change pD is required in the course of braking. The bellows pressure change pD denotes the rise in the bellows pressure pB during braking in comparison with the bellows pressure pB before braking. In this case, the maximum bellows pressure pB during braking can be used to calculate the bellows pressure change pD in order to calculate the bellows pressure change pD using the reference pressure pRef.

The formation of a sum of forces or torques produces the following equation for the relationship between the braking force FB and the supporting force FBB on the bellows 265. FB=FBB×l0/h, that is, the braking force FB, is equal to the supporting force FBB on the bellows 265 multiplied by the length l0 of a suspension link 220 divided by the height h of the mounting 230.

The calculation rule for the braking force FB, neglecting the axle load transfer (see FIG. 3) is then: FB=pD×2×Aeff×l0/h, that is, the braking force FB is equal to twice the product of the area of action Aeff and the length l0 of the suspension link 220 divided by the height h of the mounting 230. Here, the term 2×Aeff×l0/h is a vehicle-specific or vehicle-type-specific constant. A vehicle-specific or vehicle-type-specific constant can be stored in the memory of the control device 250, for example.

Specifically in the case of a semitrailer, which typically has a plurality of axles 205 grouped into an axle unit, the bellows 265 of these axles 205 are connected to one another as a whole or at least on each side. Thus, it is possible to ascertain the braking force FB of the vehicle 200a, 200b and/or of the axle unit.

FIG. 3 shows a schematic illustration of a trailer 200c as a vehicle 200a, in particular a commercial vehicle 200b, according to an aspect of the disclosure. Here, an axle 205 or a plurality of axles 205 and the pneumatic suspension system 260 of the trailer 200c can be configured as described with reference to FIG. 2. FIG. 3 is described with reference to FIGS. 1 and 2.

To enable the trailer 200c to be coupled to the tractor 200d (see FIG. 1), the trailer 200c according to FIG. 3 has a kingpin 280, via which forces can be transmitted between the trailer 200c and the tractor 200d.

In particular, it is possible, during braking of the tractor 200b, for a pin braking force FBZ, that is, a force acting via the tractor 200d on the kingpin 280 on the trailer 200c, or, in particular, the horizontal component of the force, to be transmitted. The pin braking force FBZ results from the circumstance that the tractor 200d brakes the mass of the trailer 200c resting on a fifth-wheel pick-up plate of the tractor 200d. The kingpin 280 is arranged at a pin height hZ as a vertical distance between the kingpin 280 and the underlying surface and/or the wheel contact area. The pin height hZ is a vehicle-specific or vehicle-type-specific constant.

The trailer 200c has a center of gravity 202. To establish the center of gravity 202, uniform loading of the trailer 200c can be assumed. The driving dynamics of the trailer 200c can be characterized by a vehicle deceleration D during a braking operation.

The center of gravity 202 is arranged at a center of gravity height hM, which can be estimated and/or taken from data from the braking calculation of the vehicle 200a, 200b. Deviations from the assumptions, for example, between the assumed and the actual center of gravity height hM, lead only to insignificant deviations in the following considerations. The center of gravity height hM is essentially a vehicle-specific or vehicle-type-specific constant.

If influences of the axle load transfer S during braking are taken into account, the calculation of the braking variable B or of the braking force FB and/or of the braking ratio AB can be improved. For this purpose, assumptions are made, for example, for the center of gravity height hM and the pin force FBZ transmitted by the kingpin 280. The dynamic axle load transfer S during braking leads to relief of the load on the rear axle unit of the semitrailer and thus to a force FBA on the bellows 265 due to the axle load transfer S. This force FBA on the bellows 265 due to the axle transfer S can be established by incorporating the deceleration D and the center of gravity height hM of the trailer 200c, as follows: FBA=(−m×D×hM+FBZ×hZ)×l1/(n×leff×l0), that is, force FBA on the bellows 265 due to the axle load transfer S is equal to the quotient of the distance l1 between the mounting 230 and the axle 205 and the product of the number n of axles 205, the effective wheelbase leff and the length l0 of the suspension link 220 multiplied by the sum of the product of the mass m of the vehicle 200, 200b, the deceleration D and the center of gravity height hM and the product of the pin braking force FBK and the pin height hZ. Here, the effective wheelbase leff is a measure of the horizontal distance between the kingpin 280 and the axles 205 and defines a length of a lever engaging on the kingpin 280 supported on the axles 205. If, for example, a plurality of axles 205 is equally loaded, the effective wheelbase leff is defined relative to the effective contact point. In the case of three equally loaded axles 205, for example, the effective contact point is arranged at a second, central axle 205; in the case of two equally loaded axles 205, the effective contact point is arranged precisely between the two axles 205.

The deceleration D of the vehicle 200a, 200b can be measured with the aid of an acceleration sensor and/or with the aid of wheel speed sensors. The further geometric data can be obtained from the construction of the vehicle 200a, 200b and are vehicle-specific or vehicle-type-specific constants. From the above equation for the axle load transfer, it is clear that the influences due to the axle load transfer are low on account of the effective wheelbase leff of the semitrailer or trailer 200c, which is long in relation to the center of gravity height hM and the pin height hZ.

The vehicle 200a, 200b has the control device 250. The control device 250 is, for example, a central control device or a brake control device. The control device 250 is connectable or connected to the pressure sensor 170 (see FIGS. 2 and 4) in order to capture the bellows pressure pB.

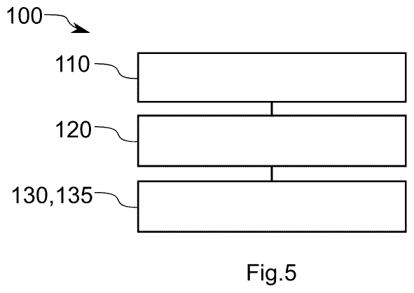

The vehicle 200a, 200b has a data processing device 255. The data processing device 255 is configured for wireless communication with a server external to the vehicle (not shown). The data processing device 255 is connected to the control device 250 in terms of communication. For determination 130 of the braking force FB or braking variable B, the control device 250 can be configured for transmitting 135 the bellows pressure change pD and/or the bellows pressure pB to the data processing device 255, which is different from the control device 250. The data processing device 255 can determine the braking variable B in accordance with the method 100 shown in FIG. 5, and/or can transmit the data received from the control device 250 to the server external to the vehicle, which determines the braking variable B. The data processing device 255 is a telematics device, for example.

FIG. 4 shows a schematic illustration of a trailer 200c as a vehicle 200a, in particular a commercial vehicle 200b, according to an aspect of the disclosure. The vehicle 200a, 200b shown in FIG. 4 is the vehicle 200a, 200b described with reference to FIG. 3. FIG. 4 is described with reference to FIGS. 1 to 3.

Here, the vehicle 200a, 200b has the axles 205 with the wheels 206 (not indicated in FIG. 4). As a component part of the braking system 290, a brake cylinder 295 is assigned to each of the wheels 206. The brake cylinder 295 of each wheel 206 can be supplied with the brake pressure BP in order to brake the wheel 206 or to exert a braking torque on the wheel 206. As a component part of the braking system 260, a bellows 265 is assigned to each of the wheels 206. The bellows pressure pB prevails in the bellows 265 of each wheel 206.

The brake pressure BP and the bellows pressure pB can be measured by the pressure sensor 270. The pressure sensor 270 is a central pressure sensor 270 for measuring the brake pressures BP in a plurality of brake cylinders 295 and for measuring the bellows pressures pB in a plurality of bellows 265. In another embodiment, the vehicle 200a, 200b can have a plurality of pressure sensors 270 for measuring the pressure in one or more respective brake cylinders 295 and/or bellows 265.

The vehicle 200a, 200b has two compressed air lines 299 for carrying an air pressure from a tractor 200d (see FIG. 1) to the trailer 200c. For storing and/or setting pressures, the vehicle 200a, 200b has two compressed air accumulators 296 and a plurality of valves 297.

The vehicle 200a, 200b has a communication link 298. The communication link 298 is configured for data transfer between the tractor 200d and the trailer 200c. The communication link 298 can be configured, for example, in accordance with ISO Standard 7638-1:2018-05 “Road vehicles—Connectors for the electrical connection of towing and towed vehicles—Part 2: Connectors for braking systems and braking equipment of vehicles with 24 V nominal supply voltage”, May 2018.

FIG. 5 shows a schematic illustration of flow chart of a method 100 according to an aspect of the disclosure. The method 100 is a method 100 for determining a braking variable B for a vehicle 200a, a commercial vehicle 200b. Such a vehicle 200a, 200b is described with reference to FIGS. 1 to 4. FIG. 5 is described with reference to FIGS. 1 to 4.

The method 100 includes: capturing 110 the bellows pressure pB.

A bellows pressure change pD is ascertained 120 on the basis of the bellows pressure pB. The bellows pressure change pD corresponds to a difference between the bellows pressure pB and a reference bellows pressure pRef at and/or before an effect of the braking variable B.

Determination 130 of the braking variable B is performed on the basis of the bellows pressure change pD. The determination 130 of the braking variable B is performed while taking account of a length L0 of the suspension link 220 and the height h of the mounting 230 of the suspension link 220 and of a ratio of the length L0 and the height h. The determination 130 of the braking variable B is performed while taking account of an area of action Aeff of the bellows 265.

The determination 130 of the braking variable B is performed while taking account of an axle load transfer S. The axle load transfer S is ascertained while taking account of a vehicle deceleration D, a center of gravity height hM, a pin braking force FBZ acting on a kingpin 280, a pin height hZ of the kingpin 280, a number n of axles 205 and/or an effective wheelbase leff.

The determination 130 of the braking variable B is performed when a braking operation exceeds a minimum braking duration. The determination 130 of the braking variable B is performed in a plurality of braking operations, and the braking variables B assigned to the braking operations are statistically evaluated. Here, the quality of braking can be weighted in respect of its suitability for evaluation according to the length of the braking process, and the continuity and/or level of the brake pressure. Braking processes that are good for evaluation are given a higher weighting in the evaluation. In other words, the braking forces FB are weighted in the statistical evaluation by being multiplied by weights, wherein more reliable braking forces FP are given a higher weighting than braking forces FB that are possibly less reliable. The braking variable B includes a braking force FB and/or a braking ratio AB.

As an option, the braking variable B is determined 130 by transmitting 135 the bellows pressure change pD and/or the bellows pressure pB to a data processing device 255, different from the control device 250, on the vehicle 200a, 200b.

The mechanical brake has a hysteresis of about 10%. That is, that, during a reduction or an increase in a brake pressure BP by 10% in the course of a braking process, the braking force FB remains substantially the same on account of frictional effects. Accordingly, the value of the braking force FB can be different during an increase in the brake pressure BP than during the lowering of the brake pressure BP. Since the profile of the brake pressure BP is known during the braking process from the fact of the braking being increased or decreased, this effect can optionally be taken into account during evaluation as a hysteresis-defining difference in the braking force FB.

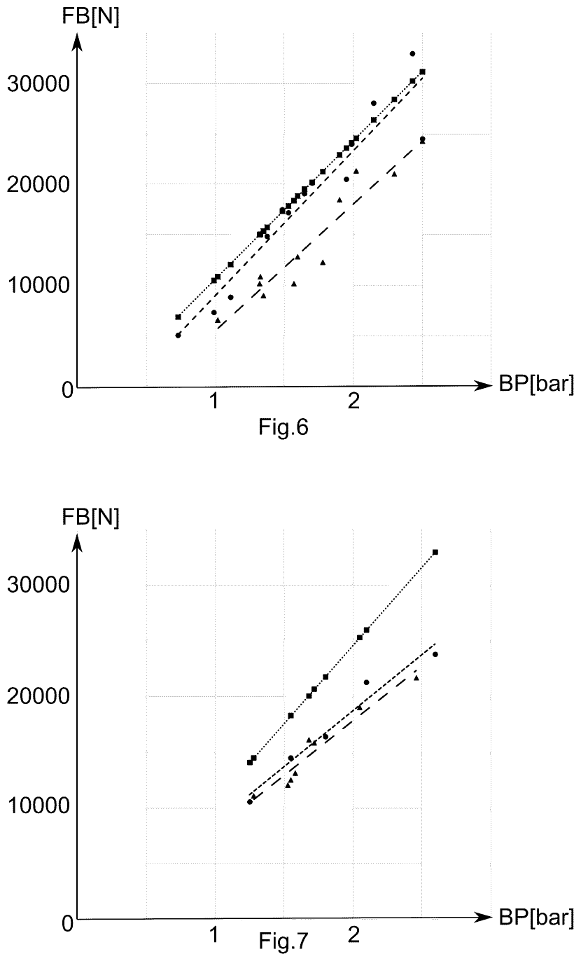

FIG. 6 shows braking forces FB obtained via a method 100 according to an aspect of the disclosure as a function of the brake pressure BP.

Here, the square symbols indicate a first measurement series for the braking force FB as a function of the brake pressure BP as reference values for the trailer 200c shown in FIGS. 1 to 4 with a raised lift axle, that is, a number n of two axles 205 making contact with the underlying surface. The reference values show a linear relationship between the braking force FB and the brake pressure BP.

The circular symbols indicate a second measurement series for the braking force FB as a function of the brake pressure BP for the trailer 200c shown in FIGS. 1 to 4 with a raised lift axle, that is, a number n of two axles 205 making contact with the underlying surface. Here, the braking force FB was determined on the basis of the bellows pressure change pD, as described with reference to FIGS. 1 to 5. The measurement series largely shows agreement and likewise shows a relationship between the braking force FB and the brake pressure BP that may be described as linear.

The triangular symbols indicate a third measurement series comparable to the second measurement series, with one of the four brake cylinders having been disconnected. The trailer 200c thus brakes only with three and not with four wheels 206. A reduced braking force FB, as compared with the second measurement series, in the case of a disconnected brake cylinder is clearly visible. It is thereby possible, for example, to diagnose a fault in a brake on the basis of the bellows pressure change pD.

FIG. 7 shows braking forces FB obtained via a method according to an aspect of the disclosure as a function of the brake pressure BP.

Here, the square symbols indicate a first measurement series for the braking force FB as a function of the brake pressure BP as reference values for the trailer 200c shown in FIGS. 1 to 3 with a raised lift axle, that is, a number n of two axles 205 making contact with the underlying surface. The reference values show a linear relationship between the braking force FB and the brake pressure BP.

The circular symbols indicate a second measurement series for the braking force FB as a function of the brake pressure BP for the trailer 200c shown in FIGS. 1 to 4. Here, the braking force FB was determined on the basis of the bellows pressure change pD, as described with reference to FIGS. 1 to 5. The measurement series largely shows agreement and likewise shows a relationship between the braking force FB and the brake pressure BP that may be described as linear.

The triangular symbols indicate a third measurement series comparable to the second measurement series, wherein the third measurement series shows the braking force FB of the multi-unit vehicle 201, that is, the tractor 200d and the trailer 200c. It is found that the measurements of the braking force FB are relatively independent of the behavior of the tractor 200d, or the behavior of the tractor 200d is comprehensively taken into account.

It is understood that the foregoing description is that of the preferred embodiments of the invention and that various changes and modifications may be made thereto without departing from the spirit and scope of the invention as defined in the appended claims.

### Reference Signs (Part of the Description)

100 Method
110 Capturing
120 Ascertainment
130 Determining
135 Method
200a Vehicle
200b Commercial vehicle
200c Trailer
200d Towing vehicle
201 Multi-unit vehicle
202 Center of gravity
205 Axle
206 Wheel
207 Axle tube
210 Vehicle frame
220 Suspension link
230 Mounting
250 Control device
255 Data processing device
260 Pneumatic suspension system
265 Bellows
270 Pressure sensor
280 Kingpin
290 Braking system
295 Brake cylinder
296 Compressed air accumulator
297 Valve
298 Communications link
299 Compressed air line
AB Braking ratio
Aeff Area of action
B Braking variable
BP Brake pressure
D Vehicle deceleration
FA Axle load
FB Braking force
FBA Force on bellows, axle load transfer
FBB Braking force on bellows
FBS Static force on bellows
FBZ Pin braking force
h Height of a mounting
hM Center of gravity height
hZ Pin height
leff Effective wheelbase
l0 Length of a suspension link
l1 Distance between mounting and axle
n Number of axles
pB Bellows pressure
pD Bellows pressure change
pRef Reference pressure
S Axle load transfer

1. A method for determining a braking variable for a vehicle, wherein the vehicle has a pneumatic suspension system having a bellows and has a pressure sensor for capturing a bellows pressure of the bellows, the method comprising:
capturing the bellows pressure;
ascertaining a bellows pressure change on a basis of the bellows pressure; and,
determining the braking variable on a basis of the bellows pressure change.

2. The method of claim 1, wherein the bellows pressure change corresponds to a difference between the bellows pressure and a reference bellows pressure at least one of: at and before an effect of the braking variable.

3. The method of claim 1, wherein said determining the braking variable is performed while taking into account a length of a suspension link mounted rotatably on a vehicle frame and at least one of a height of a mounting of the suspension link and a ratio of the length to the height.

4. The method of claim 1, wherein said determining the braking variable is performed taking into account an area of action of the bellows.

5. The method of claim 1, wherein said determining the braking variable is performed taking into account an axle load transfer.

6. The method of claim 5, wherein the axle load transfer is ascertained while considering at least one of: a vehicle deceleration, a center of gravity height, a pin braking force acting on a kingpin, a pin height of the kingpin, a number of axles and an effective wheelbase.

7. The method of claim 1, wherein said determining the braking variable is performed when a braking operation exceeds a minimum braking duration.

8. The method of claim 1, wherein the braking variable includes at least one of a braking force and a braking ratio.

9. The method of claim 1, wherein said determining the braking variable is performed in a plurality of braking operations and the braking variables assigned to the plurality of braking operations are statistically evaluated.

10. The method of claim 1, wherein the vehicle has a braking system, a control device for controlling the braking system, and a data processing device, the method further comprising:
transmitting at least one of the bellows pressure change and the bellows pressure from the control device to the data processing device.

11. The method of claim 1, wherein the vehicle is a commercial vehicle.

12. A computer program and/or computer-readable medium, comprising commands which, when the computer program or the commands is or are executed by a computer, cause the latter to carry out the method of claim 1.

13. A control device for a vehicle including a pneumatic suspension system having a bellows and the vehicle including a pressure sensor for capturing a bellows pressure of the bellows, the control device comprising:
a processor;
a non-transitory computer readable storage medium having program code stored thereon;
said program code being configured, when executed by said processor to:
capture the bellows pressure;
ascertain a bellows pressure change on a basis of the bellows pressure; and,
determine a braking variable on a basis of the bellows pressure change.

14. The control device of claim 13, wherein, for determining the braking variable, the control device is configured to transmit at least one of the bellows pressure change and the bellows pressure to a data processing device, different from the control device, on the vehicle.

15. The control device of claim 13, wherein the vehicle is a commercial vehicle.

16. A vehicle comprising:
a pneumatic suspension system including a bellows and a pressure sensor for capturing a bellows pressure of said bellows;
a control device connected to said pressure sensor;
said control device including a processor and a non-transitory computer readable storage medium having program code stored thereon;
said program code being configured, when executed by said processor to:
capture the bellows pressure;
ascertain a bellows pressure change on a basis of the bellows pressure; and,
determine a braking variable on a basis of the bellows pressure change.

17. The vehicle of claim 16, wherein the vehicle is a trailer of a multi-unit vehicle.

18. The vehicle of claim 16, wherein the vehicle is a commercial vehicle.
